(19) United States
(12) Patent Application Publication
(10) Pub. No.: US 2024/0204909 A1
(43) Pub. Date: Jun. 20, 2024

(54) DATA TRANSMISSION METHOD AND APPARATUS THEREOF

(71) Applicant: MEDIATEK INC., Hsinchu City (TW)

(72) Inventors: Ming-Wang GUO, Hsinchu City (TW); Tzu-Yun SUNG, Hsinchu City (TW); Yi-Hsuan CHUNG, Hsinchu City (TW)

(21) Appl. No.: 18/541,150

(22) Filed: Dec. 15, 2023

Related U.S. Application Data
(60) Provisional application No. 63/490,793, filed on Mar. 17, 2023.
(60) Provisional application No. 63/387,706, filed on Dec. 16, 2022.

(51) Int. Cl. H04L 1/00

(52) U.S. Cl. CPC H04L 1/0013

(57) ABSTRACT

A data transmission method is provided. The data transmission method may be applied to a first apparatus. The data transmission method may include the following steps. The first apparatus may detect a medium condition to obtain a detection result. Then, the first apparatus may receive channel information from a second apparatus. Then, the first apparatus may obtain punctured sub-channel information corresponding to a transmission bandwidth based on the detection result and the channel information. Then, the first apparatus may transmit a data frame through non-punctured sub-channels of the transmission bandwidth to the second apparatus based on the punctured sub-channel information. Then, the first apparatus may receive an acknowledgement frame from the second apparatus in response to the second apparatus receiving the data frame.

### CROSS REFERENCE TO RELATED APPLICATIONS

This application claims the benefits of U.S. Provisional Application No. 63/387,706 filed on Dec. 16, 2022 and U.S. Provisional Application No. 63/490,793 filed on Mar. 17, 2023, the entirety of which is incorporated by reference herein.

### BACKGROUND OF THE INVENTION

### Field of the Invention

The invention generally relates to data transmission technology, and more particularly, to a data transmission technology based on a puncture mechanism.

### Description of the Related Art

As demand for ubiquitous computing and networking has grown, various wireless technologies have been developed, including Wireless-Fidelity (Wi-Fi) which is a Wireless Local Area Network (WLAN) technology allowing mobile devices (such as a smartphone, a smart pad, a laptop computer, a portable multimedia player, an embedded apparatus, or the like) to obtain wireless services in a frequency band of 2.4 GHz, 5 GHZ, 6 Gz or 60 GHz.

The Institute of Electrical and Electronics Engineers (IEEE) has commercialized or developed various technological standards since an initial WLAN technology is supported using frequencies of 2.4 GHz. For example, IEEE 802.11ac supports Multi-User (MU) transmission using spatial degrees of freedom via a MU-Multiple Input-Multiple-Output (MU-MIMO) scheme in a downlink (DL) direction from an Access Point (AP) to Stations (STAs). To improve performance and meet users' demand for high-capacity and high-rate services, IEEE 802.11ax has been proposed, which uses both Orthogonal Frequency Division Multiple Access (OFDMA) and MU-MIMO in both DL and uplink (UL) directions. That is, in addition to supporting frequency and spatial multiplexing from an AP to multiple STAs, transmissions from multiple STAs to the AP are also supported in IEEE 802.11ax.

In conventional knowledge, when a transmitter device (e.g., an access point (AP)) may transmit data frame to a receiver device (e.g., a station (STA)) which corresponding to the same basic service set (BSS) as the transmitter device, the transmitter device may puncture the sub-channel (or sub-channels) which occurs interference (e.g., a device of another BSS may occupy the sub channel) in the transmission bandwidth (e.g., e.g., 160 megahertz (MHz) channel bandwidth). However, when the transmitter device determines which sub-channel needs to be punctured, the transmitter device may not concern the sub-channel which occurs interference from another BSS only at the receiver device end. That is, the transmitter device cannot detect the interference from another BSS which only occurs at the receiver device end (i.e., the transmitter cannot know this sub-channel has been occupied by another BSS). Therefore, when the transmitter device transmits the data frame to the receiver device through the non-punctured sub-channel of the transmission bandwidth, the transmission error may be occurred.

In addition, in conventional knowledge, when the AP detects the radar signals in the transmission bandwidth (i.e., the transmission bandwidth may be in the dynamic frequency selection (DFS) band of 5 GHz band), the AP may determine to not use the transmission bandwidth temporarily even if the radar signals only detected in some sub-channels of the transmission bandwidth.

Therefore, how to use the sub-channels of the transmission bandwidth more efficiently and accurately is a topic that is worthy of discussion.

### BRIEF SUMMARY OF THE INVENTION

Data transmission methods and an apparatus for data transmission are provided to overcome the problems mentioned above.

An embodiment of the invention provides a data transmission method. The data transmission method is applied to a first apparatus. The data transmission method may include the following steps. The first apparatus may detect a medium condition to obtain a detection result. Then, the first apparatus may receive channel information from a second apparatus. Then, the first apparatus may obtain punctured sub-channel information corresponding to a transmission bandwidth based on the detection result and the channel information. Then, the first apparatus may transmit a data frame through non-punctured sub-channels of the transmission bandwidth to the second apparatus based on the punctured sub-channel information. Then, the first apparatus may receive an acknowledgement frame from the second apparatus in response to the second apparatus receiving the data frame.

An embodiment of the invention provides an apparatus for data transmission. The apparatus may include a transceiver and a processor. The transceiver may be configured to perform wireless transmission and reception to and from a second apparatus. The processor may be coupled to the transceiver. The processor may be configured to detect a medium condition to obtain a detection result. In addition, the processor may be configured to receive, via the transceiver, the channel information from the second apparatus. In addition, the processor may be configured to obtain punctured sub-channel information corresponding to a transmission bandwidth based on the detection result and the channel information. In addition, the processor may be configured to transmit, via the transceiver, a data frame through non-punctured sub-channels of the transmission bandwidth to the second apparatus based on the punctured sub-channel information. In addition, the processor may be configured to receive, via the transceiver, an acknowledgement frame from the second apparatus in response to the second apparatus receiving the data frame.

An embodiment of the invention provides a data transmission method. The data transmission method is applied to a network node. The data transmission method may include the following steps. The network node may detect whether there are any radar signals in a transmission bandwidth for a data transmission. Then, the network node may puncture said sub-channel in response to there being a radar signal in at least one sub-channel of the transmission bandwidth. Then, the network node may transmit a first beacon frame to user equipment (UE) to indicate said punctured sub-channel in the transmission bandwidth.

An embodiment of the invention provides an apparatus for data transmission. The apparatus may include a transceiver and a processor. The transceiver may be configured to perform wireless transmission and reception to and from a second apparatus. The processor may be coupled to the transceiver. The processor may be configured to detect whether there are any radar signals in a transmission bandwidth for a data transmission. In addition, the processor may be configured to puncture said sub-channel in response to there being a radar signal in at least one sub-channel of the transmission bandwidth. In addition, the processor may be configured to transmit, via the transceiver, a first beacon frame to user equipment (UE) to indicate said punctured sub-channel in the transmission bandwidth.

Other aspects and features of the invention will become apparent to those with ordinary skill in the art upon review of the following descriptions of specific embodiments of the data transmission methods and the apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating an AP according to an embodiment of the application.

FIG. 4 is a flow chart illustrating a puncture process according to an embodiment of the application.

FIG. 5 is a schematic diagram illustrating a puncture process according to an embodiment of the application.

FIG. 6 is a schematic diagram illustrating a puncture process according to another embodiment of the application.

FIG. 7 is a flow chart illustrating a puncture process according to another embodiment of the application.

FIG. 8 is a schematic diagram illustrating a puncture process according to another embodiment of the application.

FIG. 9 is a flow chart illustrating a puncture process according to another embodiment of the application.

FIG. 10 is a flow chart illustrating a puncture process according to another embodiment of the application.

FIG. 11 is a flow chart illustrating a puncture process for radar signals according to an embodiment of the application.

FIG. 12 is a schematic diagram illustrating a puncture pattern list according to an embodiment of the application.

FIG. 13 is a schematic diagram illustrating a puncture pattern list according to another embodiment of the application.

FIG. 14 is a schematic diagram illustrating a puncture process according to another embodiment of the application.

FIG. 15 is a flow chart illustrating a data transmission method according to an embodiment of the invention.

FIG. 16 is a flow chart illustrating a data transmission method according to an embodiment of the invention.

FIG. 17 is a schematic diagram illustrating an embodiment of the application.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

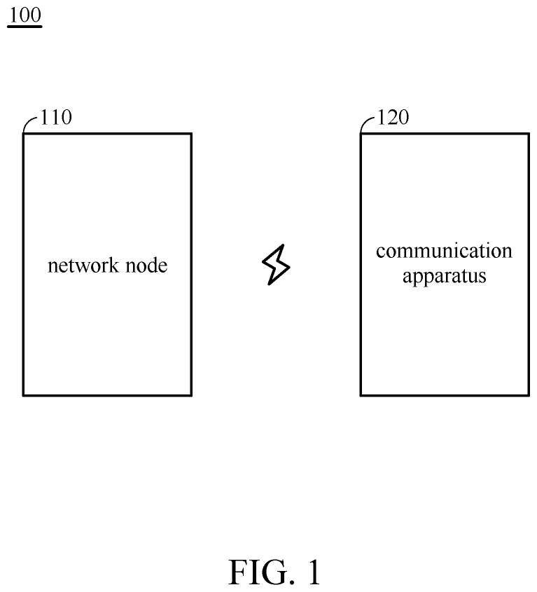

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1. The network node 110 and the communication apparatus 120 may be corresponded to a basic service set (BSS).

In an embodiment of the invention, the network node 110 may be an Extremely High Throughput (EHT) AP which is compatible with the IEEE 802.11be standards. In another embodiment of the invention, the network node 110 may be an AP which is compatible with any IEEE 802.11 standards later than 802.11be.

In the embodiments of the invention, the communication apparatus 120 may be may be user equipment (UE), a non-AP station (STA), a mobile phone (e.g., feature phone or smartphone), a panel Personal Computer (PC), a laptop computer, or any computing device, as long as it is compatible with the same IEEE 802.11 standards as the network node 110. The communication apparatus 120 may associate and communicate with the network node 110 to send or receive data in an uplink (UL) or downlink (DL) Multi-User-Physical layer Protocol Data Unit (MU-PPDU). The MU-PPDU may be a resource-unit Orthogonal Frequency Division Multiple Access (RU-OFDMA), a MU-Multiple Input-Multiple-Output (MU-MIMO) PPDU, or an aggregated PPDU.

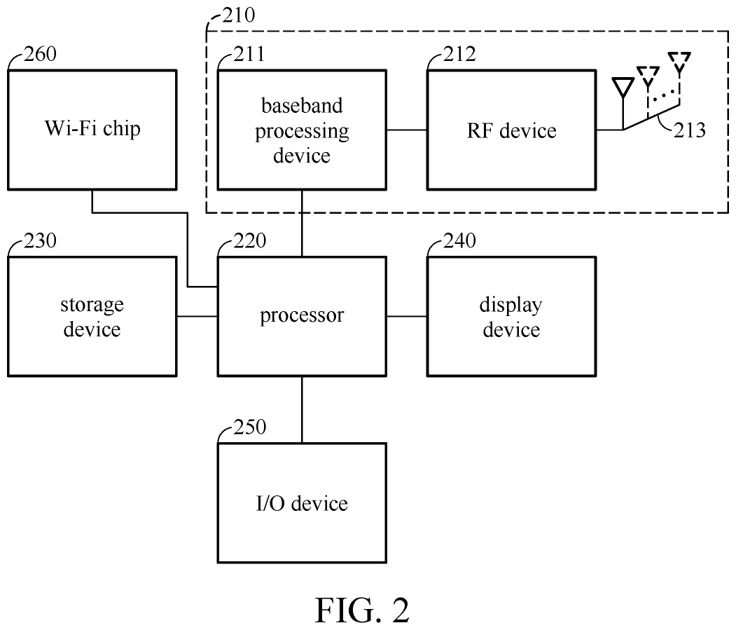

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250 and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may be configured to perform the operations of Wi-Fi communications. In another embodiment of the invention, the wireless transceiver 210 may be also combined with the Wi-Fi chip 260 to form a Wi-Fi chip.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

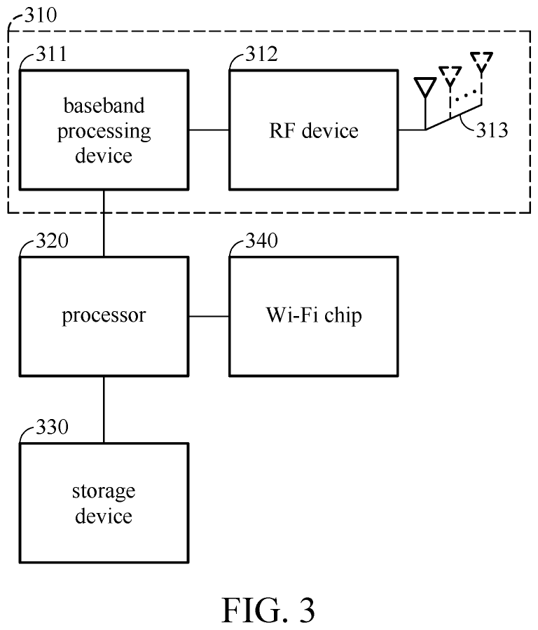

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, a storage device 330, and a Wi-Fi chip 340.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal as processing, such ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

According to an embodiment of the invention, the Wi-Fi chip 340 may be configured to perform the operations of Wi-Fi communications. In another embodiment of the invention, the wireless transceiver 310 may be also combined with the Wi-Fi chip 340 to form a Wi-Fi chip.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

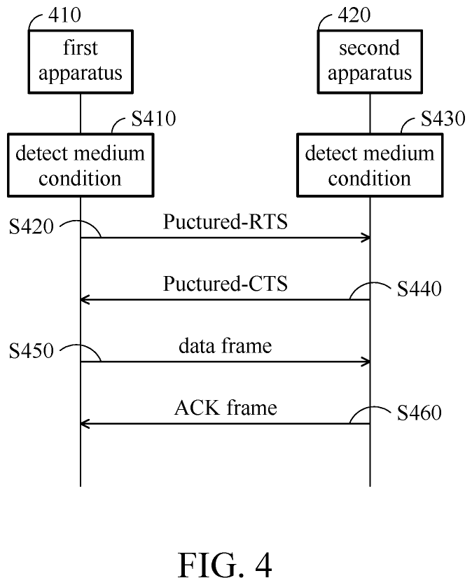

FIG. 4 is a flow chart illustrating a puncture process according to an embodiment of the application. In an example, the first apparatus 410 (i.e., the transmitter device) and the second apparatus 420 (i.e., the receiver device) may be applied to the network node 110 and the communication apparatus 120. In another example, the first apparatus 410 and the second apparatus 420 may be applied to the communication apparatus 120 and the network node 110. As shown in FIG. 4, in step S410, the first apparatus 410 may detect the medium (or channel) condition of a transmission bandwidth (e.g., 160 megahertz (MHz) channel bandwidth, but the invention should not be limited thereto) to obtain a first detection result. The first detection result may indicate which sub-channel (or sub-channels) is (or are) busy in the transmission bandwidth.

In step S420, the first apparatus 410 may transmit a control frame Punctured request-to-send (Punctured-RTS) (i.e., first channel information) to the second apparatus 420 based on the first detection result. The control frame Punctured-RTS may indicate which sub-channel is busy in the transmission bandwidth.

In step S430, the second apparatus 420 may detect the medium (or channel) condition of the transmission bandwidth (e.g., 160 MHz channel bandwidth, but the invention should not be limited thereto) to obtain a second detection result. The second detection result may indicate which sub-channel (or sub-channels) is (or are) busy in the transmission bandwidth. It should be noted that the first detection result may be different from the second detection result since the interference of the first apparatus 410 and the interference of the second apparatus 420 may be different.

In step S440, after the second apparatus 420 receives the control frame Punctured-RTS from the first apparatus 410, the second apparatus 420 may transmit a control frame Punctured clear-to-send (Punctured-CTS) (i.e., second channel information) to the first apparatus 410. The control frame Punctured-CTS may comprise the information of the control frame Punctured-RTS from the first apparatus 410. That is, the control frame Punctured-CTS may indicate the busy sub-channels from the first detection result and the second detection result, i.e., the second apparatus 420 may obtain a union from the first detection result and the second detection result to generate the control frame Punctured-CTS.

In step S450, after the first apparatus 410 receives the control frame Punctured-CTS from the second apparatus 420, the first apparatus 410 may transmit a data frame according to the control frame Punctured-CTS. That is, the first apparatus 410 may obtain the punctured sub-channel information according to the control frame Punctured-CTS, and then transmit the data frame through the non-punctured sub-channels of the transmission bandwidth.

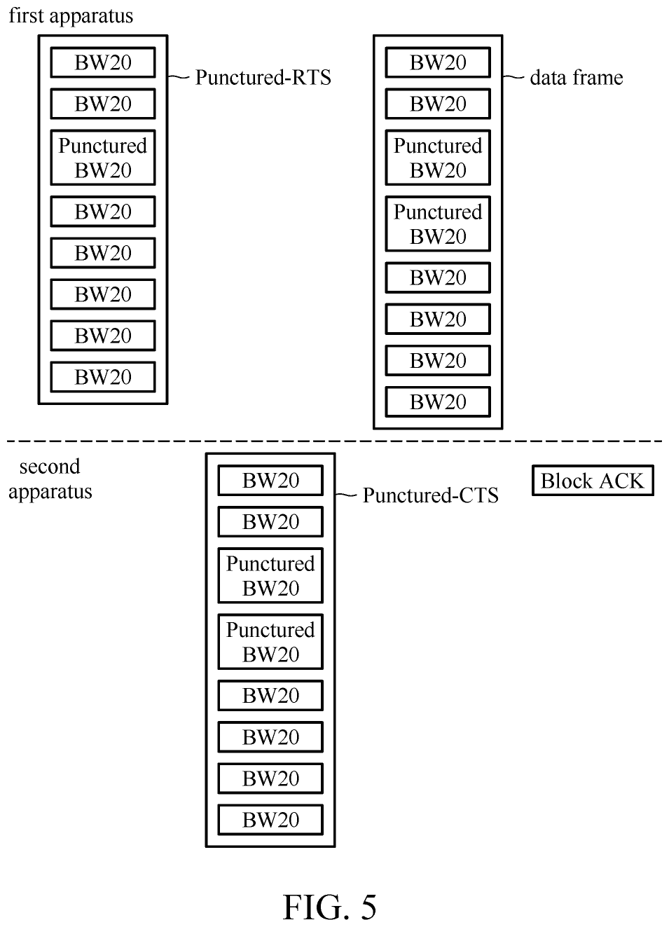

In step S460, when the second apparatus 420 receives the data frame from the first apparatus 410, the second apparatus 420 may transmit an acknowledgement (ACK) frame (e.g., block ACK (BA)) to the first apparatus 410. FIG. 5 is taken as an example to illustrate the embodiment of FIG. 4.

FIG. 5 is a schematic diagram illustrating a puncture process according to an embodiment of the application. As shown in FIG. 5, it is assumed that the first apparatus (e.g., first apparatus 410) may transmit data frame to the second apparatus (e.g., second apparatus 420) through a 160 MHz channel bandwidth which comprises eight 20 MHz sub-channels (BW20). The first apparatus may detect the 160 MHz channel bandwidth (i.e., detect the medium condition). When the first apparatus detects that the third 20 MHz sub-channel of the 160 MHz channel bandwidth is busy, the first apparatus may transmit the control frame Punctured-RTS to the second apparatus to indicate that the third 20 MHz sub-channel is punctured. In addition, the second apparatus may also detect the 160 MHz channel bandwidth (i.e., detect the medium condition). The second apparatus may detect that the fourth 20 MHz sub-channel of the 160 MHz channel bandwidth is busy. Then, when the second apparatus receives the control frame Punctured-RTS from the first apparatus, the second apparatus may transmit the control frame Punctured-CTS to the first apparatus to indicate that the third 20 MHz sub-channel and the fourth 20 MHz sub-channel of the 160 MHz channel bandwidth need to be punctured. Therefore, when the first apparatus receives the control frame Punctured-CTS from the second apparatus, the first apparatus may transmit the data frame through the non-punctured 20 MHz sub-channels of the 160 MHz channel bandwidth. In addition, when the second apparatus receives the data frame from the first apparatus, the second apparatus may transmit an ACK frame to the first apparatus. It should be noted that FIG. 5 is only an example to illustrate the embodiment of the invention, but the invention should not be limited thereto.

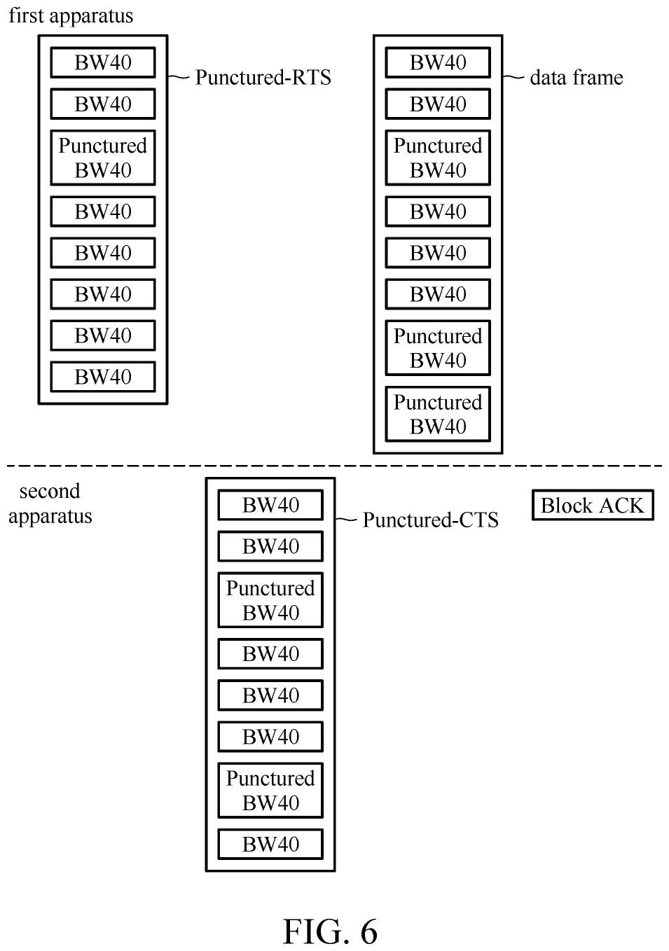

According to an embodiment of the invention, in step S450, before the first apparatus 410 transmits the data frame to the second apparatus 420 according to the control frame Punctured-CTS, the first apparatus 410 may further determine whether the punctured sub-channels indicated in the control frame Punctured-CTS meet a specified puncture pattern list defined in the standards. Specifically, the first apparatus 410 may obtain the punctured sub-channel information according to the control frame Punctured-CTS first, and then the first apparatus 410 ma determine whether the pattern of the punctured sub-channels can match one specified puncture pattern of the specified puncture pattern list defined in the standards. If the punctured sub-channels meet the specified puncture pattern list, the first apparatus 410 may transmit the data frame through the non-punctured sub-channels of the transmission bandwidth. If the punctured sub-channels do not meet the specified puncture pattern list, the first apparatus 410 may puncture one or more of remaining non-punctured sub-channels of the transmission bandwidth to meet the specified puncture pattern list, or the first apparatus 410 may perform normal operations. FIG. 6 is taken as an example to illustrate the embodiment below.

FIG. 6 is a schematic diagram illustrating a puncture process according to another embodiment of the application. As shown in FIG. 6, it is assumed that the first apparatus (e.g., first apparatus 410) may transmit data frame to the second apparatus (e.g., second apparatus 420) through a 320 MHz channel bandwidth which comprises eight 40 MHz sub-channels (BW40). The first apparatus may detect the 320 MHz channel bandwidth (i.e., detect the medium condition). When the first apparatus detects that the third 40 MHz sub-channel of the 320 MHz channel bandwidth is busy, the first apparatus may transmit the control frame Punctured-RTS to the second apparatus to indicate that the third 40 MHz sub-channel is punctured. In addition, the second apparatus may also detect the 320 MHz channel bandwidth (i.e., detect the medium condition). The second apparatus may detect that the seventh 40 MHz sub-channel of the 320 MHz channel bandwidth is busy. Then, when the second apparatus receives the control frame Punctured-RTS from the first apparatus, the second apparatus may transmit the control frame Punctured-CTS to the first apparatus to indicate that the third 40 MHz sub-channel and the seventh 40 MHz sub-channel of the 320 MHz channel bandwidth need to be punctured. However, in order to meet the specified puncture pattern list defined in the standards, the eighth 40 MHz sub-channel also needs to be punctured. Therefore, when the first apparatus receives the control frame Punctured-CTS from the second apparatus, the first apparatus may further puncture the eighth 40 MHz sub-channel. Then, the first apparatus may transmit the data frame through the remaining non-punctured 40 MHz sub-channels of the 320 MHz channel bandwidth. In addition, when the second apparatus receives the data frame from the first apparatus, the second apparatus may transmit an ACK frame to the first apparatus. It should be noted that FIG. 6 is only an example to illustrate the embodiment of the invention, but the invention should not be limited thereto.

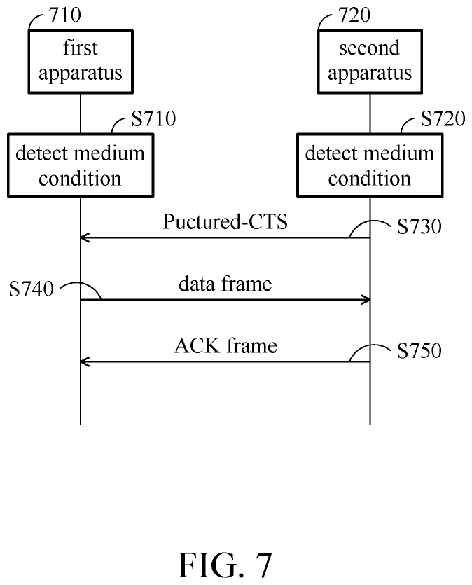

FIG. 7 is a flow chart illustrating a puncture process according to another embodiment of the application. In an example, the first apparatus 710 (i.e., the transmitter device) and the second apparatus 720 (i.e., the receiver device) may be applied to the network node 110 and the communication apparatus 120. In another example, the first apparatus 710 and the second apparatus 720 may be applied to the communication apparatus 120 and the network node 110. As shown in FIG. 7, in step S710, the first apparatus 710 may detect the medium (or channel) condition of a transmission bandwidth (e.g., 160 MHz channel bandwidth, but the invention should not be limited thereto) to obtain a first detection result. The first detection result may indicate which sub-channel (or sub-channels) is (or are) busy in the transmission bandwidth.

In step S720, the second apparatus 720 may detect the medium (or channel) condition of the transmission bandwidth (e.g., 160 MHz channel bandwidth, but the invention should not be limited thereto) to obtain a second detection result. The second detection result may indicate which sub-channel (or sub-channels) is (or are) busy in the transmission bandwidth. It should be noted that the first detection result may be different from the second detection result since the interference of the first apparatus 710 and the interference of the second apparatus 720 may be different.

In step S730, the second apparatus 720 may transmit a control frame Punctured clear-to-send (Punctured-CTS) (i.e., second channel information) to the first apparatus 710 based on the second detection result.

In step S740, after the first apparatus 710 receives the control frame Punctured-CTS from the second apparatus 720, the first apparatus 710 may transmit a data frame according to the control frame Punctured-CTS and the first detection result. That is, the first apparatus 710 may obtain the punctured sub-channel information according to the control frame Punctured-CTS and the first detection result, i.e., the first apparatus 710 may obtain a union from the first detection result and the control frame Punctured-CTS, and then transmit the data frame through the non-punctured sub-channels of the transmission bandwidth. According to an embodiment of the invention, in step S740, before the first apparatus 710 transmits the data frame to the second apparatus 720 according to the control frame Punctured-CTS and the first detection result, the first apparatus 710 may further determine whether the punctured sub-channels indicated in the control frame Punctured-CTS and the first detection result meet the specified puncture pattern list defined in the standards.

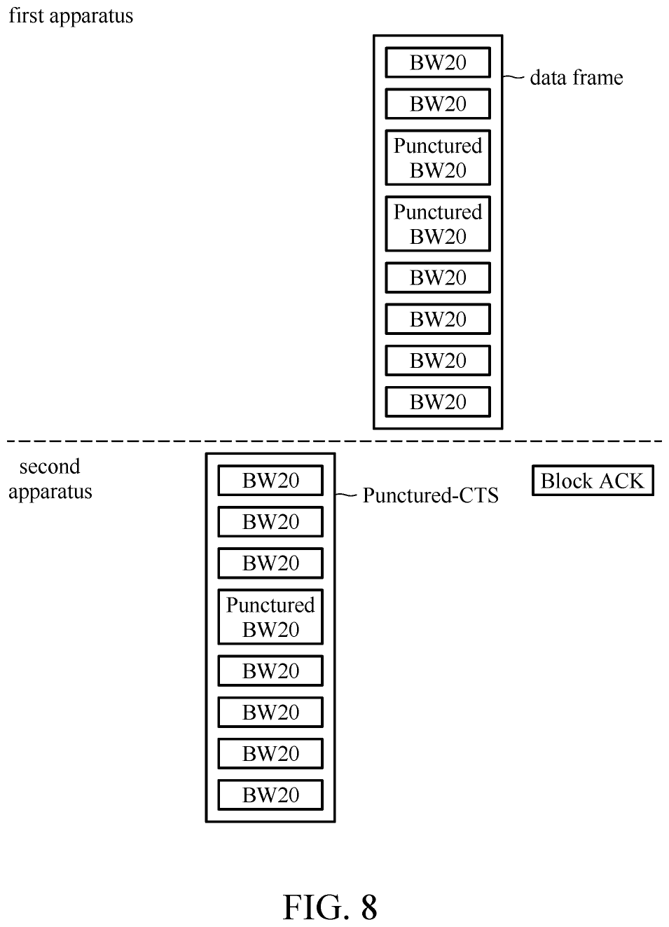

In step S750, when the second apparatus 720 receives the data frame from the first apparatus 710, the second apparatus 720 may transmit an acknowledgement (ACK) frame to the first apparatus 710. FIG. 8 is taken as an example to illustrate the embodiment of FIG. 8.

FIG. 8 is a schematic diagram illustrating a puncture process according to an embodiment of the application. As shown in FIG. 8, it is assumed that the first apparatus (e.g., first apparatus 710) may transmit data frame to the second apparatus (e.g., second apparatus 720) through a 160 MHz channel bandwidth which comprises eight 20 MHz sub-channels (BW20). The first apparatus may detect the 160 MHz channel bandwidth (i.e., detect the medium condition). In addition, the second apparatus may also detect the 160 MHz channel bandwidth (i.e., detect the medium condition). The second apparatus may detect that the fourth 20 MHz sub-channel of the 160 MHz channel bandwidth is busy. Then, the second apparatus may transmit the control frame Punctured-CTS to the first apparatus to indicate that the fourth 20 MHz sub-channel of the 160 MHz channel bandwidth need to be punctured. Therefore, when the first apparatus receives the control frame Punctured-CTS from the second apparatus, the first apparatus may transmit the data frame through the non-punctured sub-channels of the 160 MHz channel bandwidth according to the control frame Punctured-CTS and its detection result, i.e., the third 20 MHz sub-channel and the fourth 20 MHz sub-channel of the 160 MHz channel bandwidth are punctured. In addition, when the second apparatus receives the data frame from the first apparatus, the second apparatus may transmit an ACK frame to the first apparatus. It should be noted that FIG. 8 is only an example to illustrate the embodiment of the invention, but the invention should not be limited thereto.

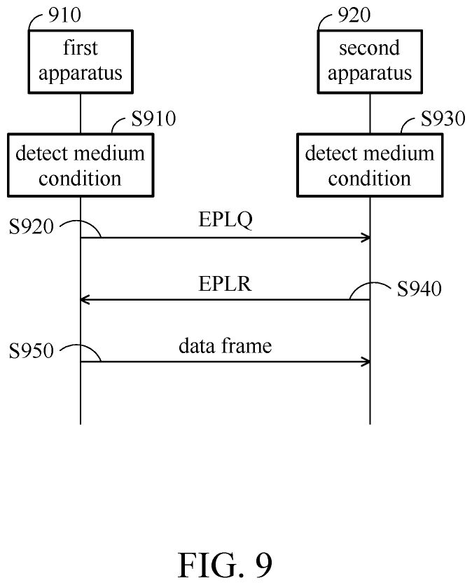

FIG. 9 is a flow chart illustrating a puncture process according to another embodiment of the application. In an example, the first apparatus 910 (i.e., the transmitter device) and the second apparatus 920 (i.e., the receiver device) may be applied to the network node 110 and the communication apparatus 120. In another example, the first apparatus 910 and the second apparatus 920 may be applied to the communication apparatus 120 and the network node 110. As shown in FIG. 9, in step S910, the first apparatus 410 may detect the medium (or channel) condition of a transmission bandwidth (e.g., 160 MHz channel bandwidth, but the invention should not be limited thereto) to obtain a first detection result. The first detection result may indicate which sub-channel (or sub-channels) is (or are) busy in the transmission bandwidth.

In step S920, the first apparatus 910 may transmit a first management frame (i.e., first channel information) to the second apparatus 920 based on the first detection result. The first management frame (e.g., an explicit puncture learning query (EPLQ)) may indicate which sub-channel is busy in the transmission bandwidth. According to an embodiment of the invention, the information of first the management frame (e.g., EPLQ) may be carried in the fields of the Protected EHT Action frame (e.g., Category field values, Protected EHT Action field values, EHT Operation Information format, and so on), but the invention should not be limited thereto.

In step S930, the second apparatus 920 may detect the medium (or channel) condition of the transmission bandwidth (e.g., 160 MHz channel bandwidth, but the invention should not be limited thereto) to obtain a second detection result. The second detection result may indicate which sub-channel (or sub-channels) is (or are) busy in the transmission bandwidth. It should be noted that the first detection result may be different from the second detection result since the interference of the first apparatus 910 and the interference of the second apparatus 920 may be different.

In step S940, after the second apparatus 920 receives the first management frame (e.g., EPLQ) from the first apparatus 910, the second apparatus 920 may transmit a second management frame (i.e., second channel information) to the first apparatus 910. The second management frame (e.g., explicit puncture learning request (EPLR)) may comprise the information of the first management frame (e.g., EPLQ) from the first apparatus 910. That is, the second management frame (e.g., EPLR) may indicate the busy sub-channels from the first detection result and the second detection result, i.e., the second apparatus 920 may obtain a union from the first detection result and the second detection result to generate the second management frame (e.g., EPLR).

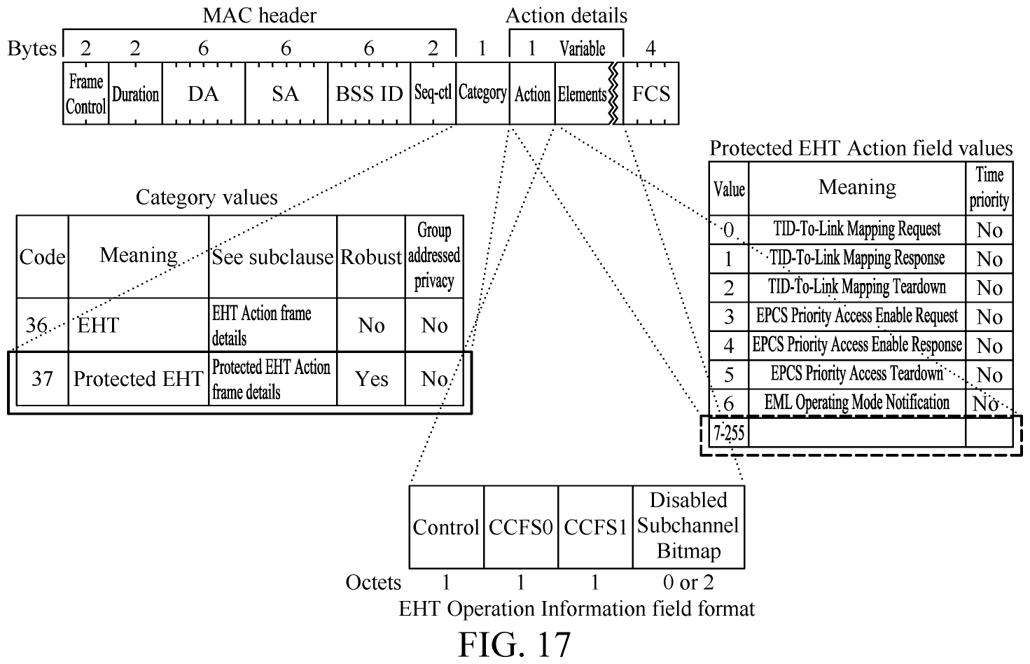

According to an embodiment of the invention, as shown in FIG. 17, the information of the first management frame (e.g., EPLQ) and the second management frame (e.g., EPLR) may be carried in the fields (e.g., Category field values, Protected EHT Action field values, EHT Operation Information field format, and so on) of the Protected EHT Action frame, but the invention should not be limited thereto, i.e., other frame formats also can be applied to the invention. For example, as shown in FIG. 17, the Code 37 of the Category field may be associated with the management frames EPLQ and EPLR. In addition, the EHT Operation Information field format may indicate which sub-channel is busy based on the management frames EPLQ and EPLR. Moreover, the reserved field (e.g., the empty fields 7-255) of the Protected EHT Action field may be used to descript the values, meanings and time priorities for the management frames EPLQ and EPLR.

In step S950, after the first apparatus 910 receives the second management frame (e.g., EPLR) from the second apparatus 920, the first apparatus 910 may transmit a data frame according to the second management frame (e.g., EPLR). That is, the first apparatus 910 may obtain the punctured sub-channel information according to the second management frame (e.g., EPLR), and then transmit the data frame through the non-punctured sub-channels of the transmission bandwidth.

According to an embodiment of the invention, in step S950, before the first apparatus 910 transmits the data frame to the second apparatus 920 according to the second management frame (e.g., EPLR), the first apparatus 910 may further determine whether the punctured sub-channels indicated in the second management frame (e.g., EPLR) meet the specified puncture pattern list defined in the standards.

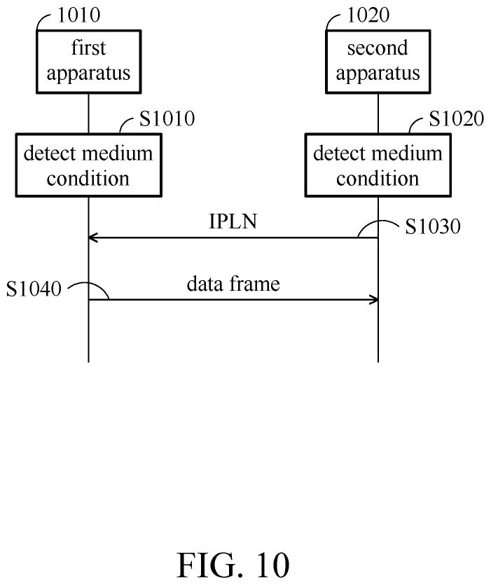

FIG. 10 is a flow chart illustrating a puncture process according to another embodiment of the application. In an example, the first apparatus 1010 (i.e., the transmitter device) and the second apparatus 1020 (i.e., the receiver device) may be applied to the network node 110 and the communication apparatus 1020. In another example, the first apparatus 1010 and the second apparatus 1020 may be applied to the communication apparatus 120 and the network node 110. As shown in FIG. 10, in step S1010, the first apparatus 1010 may detect the medium (or channel) condition of a transmission bandwidth (e.g., 160 megahertz (MHz) channel bandwidth, but the invention should not be limited thereto) to obtain a first detection result. The first detection result may indicate which sub-channel (or sub-channels) is (or are) busy in the transmission bandwidth.

In step S1020, the second apparatus 1020 may detect the medium (or channel) condition of the transmission bandwidth (e.g., 160 MHz channel bandwidth, but the invention should not be limited thereto) to obtain a second detection result. The second detection result may indicate which sub-channel (or sub-channels) is (or are) busy in the transmission bandwidth. It should be noted that the first detection result may be different from the second detection result since the interference of the first apparatus 1010 and the interference of the second apparatus 1020 may be different.

In step S1030, the second apparatus 1020 may transmit a second management frame (i.e., second channel information) to the first apparatus 1010 based on the second detection result. According to an embodiment of the invention, as shown in FIG. 17, the information of the second management frame (e.g., an Implicit Puncture Learning Notify (IPLN)) may be carried in the fields (e.g., Category field values, Protected EHT Action field values, EHT Operation Information field format, and so on) of the Protected EHT Action frame, but the invention should not be limited thereto, i.e., other frame formats also can be applied to the invention. For example, the Code 37 of the Category field may be associated with the management frame IPLN. In addition, the EHT Operation Information field format may indicate which sub-channel is busy based on the management frame IPLN. Moreover, the reserved field (e.g., the empty fields 7-255) of the Protected EHT Action field may be used to descript the values, meanings and time priorities for the management frame IPLN.

In step S1040, after the first apparatus 1010 receives the second management frame (e.g., IPLN) from the second apparatus 1020, the first apparatus 1010 may transmit a data frame according to the second management frame (e.g., IPLN) and the first detection result. That is, the first apparatus 1010 may obtain the punctured sub-channel information according to the second management frame (e.g., IPLN) and the first detection result i.e., the first apparatus 1010 may obtain a union from the first detection result and the second management frame (e.g., IPLN), and then transmit the data frame through the non-punctured sub-channels of the transmission bandwidth. According to an embodiment of the invention, in step S1040, before the first apparatus 1010 transmits the data frame to the second apparatus 1020 according to the second management frame (e.g., IPLN) and the first detection result, the first apparatus 1010 may further determine whether the punctured sub-channels indicated in the second management frame (e.g., IPLN) and the first detection result meet the specified puncture pattern list defined in the standards.

According to the above embodiments of the invention, when the transmitter device determines to puncture which sub-channel (or sub-channels) in the transmission bandwidth, the transmitter device may also concern the channel condition of the receiver device. Therefore, the transmission error will be reduced.

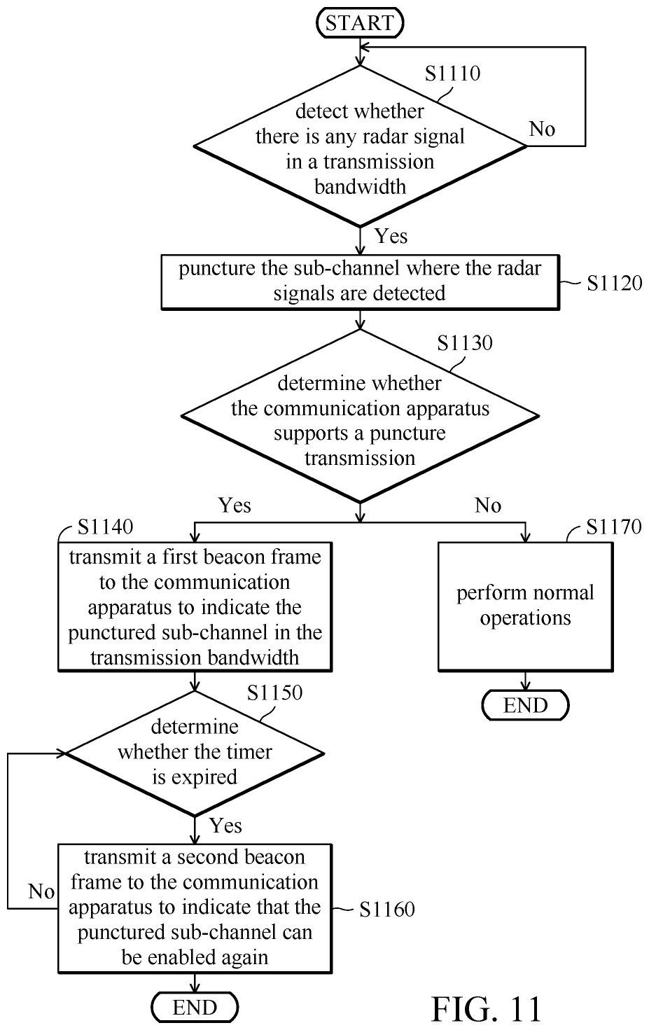

FIG. 11 is a flow chart illustrating a puncture process for radar signals according to an embodiment of the application. The puncture process can be applied to the network node 110 and the communication apparatus 120. As shown in FIG. 11, in step S1110, the network node 110 may detect whether there are any radar signals in a transmission bandwidth (e.g., 160 MHz channel bandwidth, but the invention should not be limited thereto). Specifically, the transmission bandwidth may be in the dynamic frequency selection (DFS) band of 5 GHz band. Therefore, radar signals may be detected in the transmission bandwidth. The network node 110 may detect which sub-channel of the transmission bandwidth has radar signals.

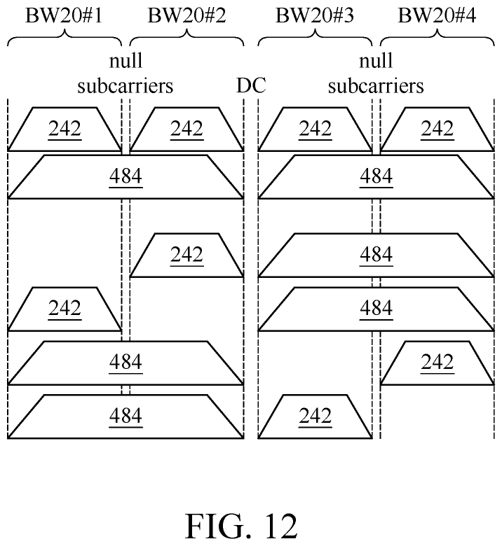

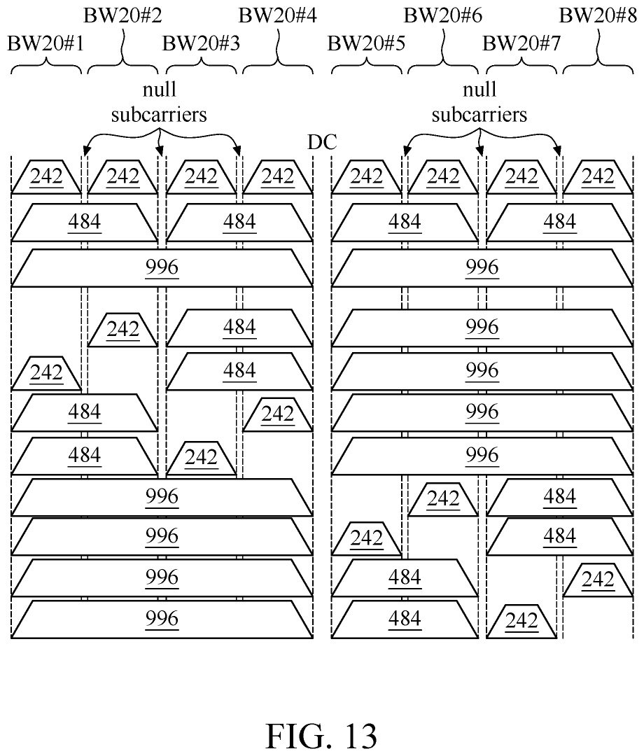

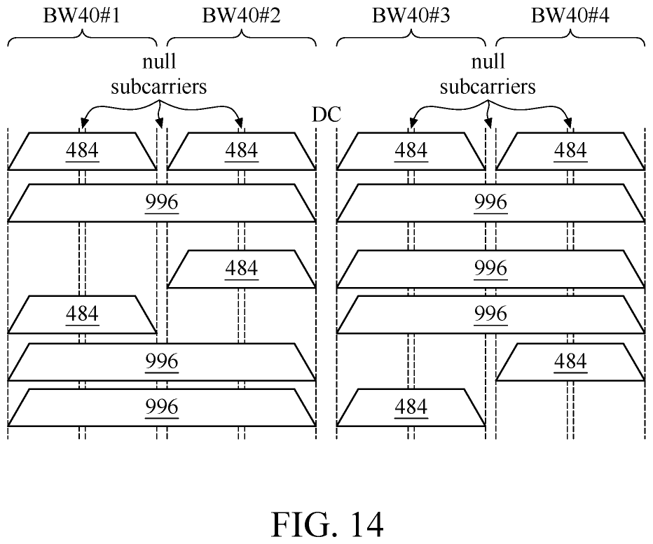

When the network node 110 has detected radar signals in the transmission bandwidth, step S1120 is performed. In step S1120, the network node 110 may puncture the sub-channel (or sub-channels) where the radar signals have been detected. According to an embodiment of the invention, the network node 110 may further determine whether the the punctured sub-channels meet the specified puncture pattern list (e.g., the specified puncture pattern list shown in FIG. 12, FIG. 13 or FIG. 14, but the invention should not be limited thereto, i.e., other puncture pattern lists defined in IEEE 802.11 standards also can be adopted in the invention) defined in the standards. If the punctured sub-channels meet the specified puncture pattern list, the network node 110 may transmit the data frame through the non-punctured sub-channels of the transmission bandwidth. If the punctured sub-channels do not meet the specified puncture pattern list, the network node 110 may perform a normal mechanism (or normal operation) to transmit the data frame.

In step S1130, the network node 110 may determine whether the communication apparatus 120 supports a puncture transmission. That is, the network node 110 may determine whether the puncture transmission is compatible with the communication apparatus 120. For example, if the communication apparatus 120 is a Wi-Fi STA whose version is prior to the Wi-Fi 7 (e.g., Wi-Fi 6, Wi-Fi 5, and so on), the communication apparatus 120 may not support the single user (SU) puncture transmission for uplink (UL) transmission and downlink (DL) transmission. When the communication apparatus 120 does not support the puncture transmission, step S1170 is performed. In step S1170, the network node 110 may perform normal operations for data transmission.

When the communication apparatus 120 supports the puncture transmission, step S1140 is performed. In step S1140, the network node 110 may transmit a first beacon frame to the communication apparatus 120 to indicate the punctured sub-channel (or sub-channels) in the transmission bandwidth. Then, the network node 110 may perform data transmission with the communication apparatus 120 through the non-punctured sub-channels of the transmission bandwidth. According to an embodiment of the invention, the information of the first beacon may be carried in the EHT operation information fields, but the invention should not be limited thereto.

In addition, when the sub-channel is punctured of the transmission bandwidth, a timer (e.g. 30 minutes) may be enabled. In step S1150, the network node 110 may determine whether the timer is expired. That is, the punctured sub-channel cannot be used for transmission or reception until the timer has been expired.

When the network node 110 timer has been expired and there is no radar signal in the punctured sub-channels, step S1160 is performed. In step S1160, the network node 110 may transmit a second beacon frame to the communication apparatus 120 to indicate that the punctured sub-channel can be enabled again.

FIG. 12 is a schematic diagram illustrating a puncture pattern list according to an embodiment of the application. As shown in FIG. 12, it is assumed that the transmission bandwidth is 80 MHz channel bandwidth which may comprise sub-channels BW20 #1˜BW20 #4. When the network node 110 detects the radar signal in the BW20 #1 of the 80 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #1 of the 80 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #2 of the 80 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #2 of the 80 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, when the network node 110 detects the radar signal in the BW20 #3 of the 80 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #3 of the 80 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #4 of the 80 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #4 of the 80 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, in the embodiment, when the punctured sub-channel does not meet puncture pattern list shown in FIG. 12, the network node 110 may also perform normal operations for data transmission.

FIG. 13 is a schematic diagram illustrating a puncture pattern list according to another embodiment of the application. As shown in FIG. 13, it is assumed that the transmission bandwidth is 160 MHz channel bandwidth which may comprise sub-channels BW20 #1˜BW20 #8. When the network node 110 detects the radar signal in the BW20 #1 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #1 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #2 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #2 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #3 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #3 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, when the network node 110 detects the radar signal in the BW20 #4 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #4 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #5 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #5 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #6 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #6 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, when the network node 110 detects the radar signal in the BW20 #7 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #7 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW20 #8 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW20 #8 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, in the embodiment, when the punctured sub-channel does not meet puncture pattern list shown in FIG. 13, the network node 110 may also perform normal operations for data transmission.

FIG. 14 is a schematic diagram illustrating a puncture pattern list according to another embodiment of the application. As shown in FIG. 14, it is assumed that the transmission bandwidth is 160 MHz channel bandwidth which may comprise sub-channels BW40 #1˜ BW40 #4. When the network node 110 detects the radar signal in the BW40 #1 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW40 #1 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW40 #2 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW40 #2 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, when the network node 110 detects the radar signal in the BW40 #3 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW40 #3 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission. In addition, when the network node 110 detects the radar signal in the BW40 #4 of the 160 MHz channel bandwidth, the network node may determine whether the communication apparatus 120 is a Wi-Fi 7 STA (or a newer version than Wi-Fi 7). When the communication apparatus 120 is a Wi-Fi 7 STA, the network node 110 may puncture the BW40 #4 of the 160 MHz channel bandwidth. When the communication apparatus 120 is not a Wi-Fi 7 STA (e.g., a legacy Wi-Fi STA, e.g., Wi-Fi 6 STA, and so on), the network node 110 may perform normal operations for data transmission.

In addition, in the embodiment, when the punctured sub-channel does not meet puncture pattern list shown in FIG. 14, the network node 110 may also perform normal operations for data transmission.

According to the above embodiments of the invention, when the network node 110 detects the radar signal in the transmission bandwidth, the network node 110 may only puncture the sub-channel with interference in the transmission bandwidth. The non-punctured sub-channel of the transmission bandwidth can be used continuously. Therefore, better bandwidth (spectrum) usage efficiency can be achieved.

It should be noted that FIG. 12˜FIG. 14 only some examples of the puncture pattern lists for illustrating the embodiments of the invention, but the invention should not be limited thereto. Other puncture pattern lists specified in standards also can be applied in the invention.

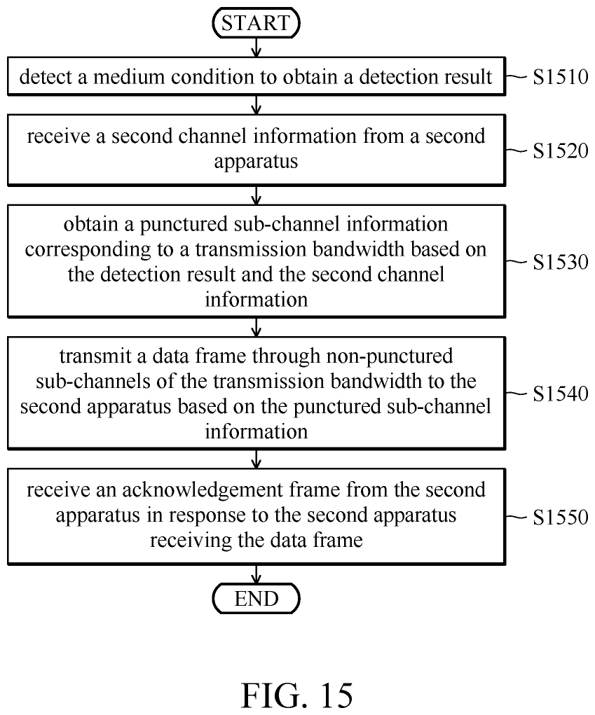

FIG. 15 is a flow chart illustrating a data transmission method according to an embodiment of the invention. The data transmission method can be applied to the wireless communication system 100. As shown in FIG. 15, in step S1510, the first apparatus (e.g., the network node 110 or the communication apparatus 120) of the wireless communication system 100 may detect a medium condition to obtain a detection result.

In step S1520, the first apparatus of the wireless communication system 100 may receive the second channel information from a second apparatus (e.g., the communication apparatus 120 or the network node 110) of the wireless communication system 100.

In step S1530, the first apparatus of the wireless communication system 100 may obtain the punctured sub-channel information corresponding to a transmission bandwidth based on the detection result and the second channel information.

In step S1540, the first apparatus of the wireless communication system 100 may transmit a data frame through non-punctured sub-channels of the transmission bandwidth to the second apparatus based on the punctured sub-channel information.

In step S1550, the first apparatus of the wireless communication system 100 may receive an acknowledgement (ACK) frame from the second apparatus in response to the second apparatus receiving the data frame.

According to an embodiment of the invention, in the data transmission method, the first apparatus of the wireless communication system 100 may further transmit the first channel information to the second apparatus based on the detection result, wherein the second channel information comprises the first channel information. In addition, the first apparatus of the wireless communication system 100 may obtain the punctured sub-channel information corresponding to the transmission bandwidth based on the second channel information.

According to an embodiment of the invention, in the data transmission method, the first channel information and the second channel information may be control frames. According to another embodiment of the invention, in the data transmission method, the first channel information and the second channel information may be management frames.

According to an embodiment of the invention, in the data transmission method, the first apparatus of the wireless communication system 100 may further transmit the data frame through non-punctured sub-channels of the transmission bandwidth based on the punctured sub-channel information and a specified puncture pattern list.

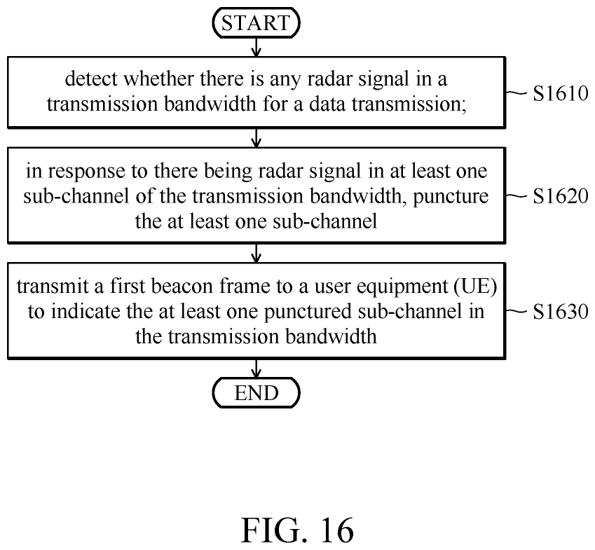

FIG. 16 is a flow chart illustrating a data transmission method according to an embodiment of the invention. The data transmission method can be applied to the wireless communication system 100. As shown in FIG. 16, in step S1610, the network node 110 of the wireless communication system 100 may detect whether there are any radar signals in a transmission bandwidth for a data transmission.

In step S1620, in response to there being a radar signal in at least one sub-channel of the transmission bandwidth, the network node 110 of the wireless communication system 100 may puncture the processor, the at least one sub-channel.

In step S1630, in response to there being a radar signal in at least one sub-channel of the transmission bandwidth, the network node 110 of the wireless communication system 100 may transmit a first beacon frame to the communication apparatus 120 of the wireless communication system 100 to indicate the at least one punctured sub-channel in the transmission bandwidth.

According to an embodiment of the invention, in the data transmission method, the network node 110 of the wireless communication system 100 may further determine whether the communication apparatus 120 of the wireless communication system 100 supports a puncture transmission. In response to the communication apparatus 120 of the wireless communication system 100 supporting the puncture transmission, the network node 110 of the wireless communication system 100 may transmit the first beacon frame to the communication apparatus 120 of the wireless communication system 100 to indicate the at least one punctured sub-channel in the transmission bandwidth. In response to the communication apparatus 120 of the wireless communication system 100 not supporting the puncture transmission, the network node 110 of the wireless communication system 100 may perform the data transmission according to a normal operation.

According to an embodiment of the invention, in the data transmission method, the network node 110 of the wireless communication system 100 may further enable a timer for the at least one punctured sub-channel. In addition, the network node 110 of the wireless communication system 100 may transmit a second beacon frame to the UE in response to the timer being expired and there being no radar signal in the at least one punctured sub-channel. The second beacon frame indicates that the at least one punctured sub-channel is enabled again.

According to an embodiment of the invention, in the data transmission method, the network node 110 of the wireless communication system 100 may further determine whether the at least one sub-channel which needs to be punctured meets a specified puncture pattern list. The network node 110 of the wireless communication system 100 may puncture the at least one sub-channel in response to the at least one sub-channel meeting the specified puncture pattern list.

In the data transmission methods provided in the invention, when the transmitter device determines to puncture which sub-channel (or sub-channels) in the transmission bandwidth, the transmitter device may also concern the channel condition of the receiver device. Therefore, the transmission error will be reduced. In addition, in the data transmission methods provided in the invention, when the network node detects the radar signal in the transmission bandwidth, the network node may only puncture the sub-channel with interference in the transmission bandwidth. The non-punctured sub-channel of the transmission bandwidth can be used continuously. Therefore, better bandwidth (spectrum) usage efficiency can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission method, comprising:
detecting, by a processor of a first apparatus, a medium condition to obtain a detection result;
receiving, by the processor, a second channel information from a second apparatus;
obtaining, by the processor, a punctured sub-channel information corresponding to a transmission bandwidth based on the detection result and the second channel information;
transmitting, by the processor, a data frame through non-punctured sub-channels of the transmission bandwidth to the second apparatus based on the punctured sub-channel information; and
receiving, by the processor, an acknowledgement frame from the second apparatus in response to the second apparatus receiving the data frame.

2. The data transmission method of claim 1, further comprising:
transmitting, by the processor, a first channel information to the second apparatus based on the detection result, wherein the second channel information comprises the first channel information; and
obtaining, by the processor, the punctured sub-channel information corresponding to the transmission bandwidth based on the second channel information.

3. The data transmission method of claim 2, wherein the first channel information and the second channel information are control frames.

4. The data transmission method of claim 2, wherein the first channel information and the second channel information are management frames.

5. The data transmission method of claim 1, further comprising:
transmitting, by the processor, the data frame through non-punctured sub-channels of the transmission bandwidth based on the punctured sub-channel information and a specified puncture pattern list.

6. An apparatus for data transmission, comprising:
a transceiver, configured to perform wireless transmission and reception to and from a second apparatus;
a processor, coupled to the transceiver, and configured to:
detect a medium condition to obtain a detection result;
receive, via the transceiver, a second channel information from the second apparatus;
obtain a punctured sub-channel information corresponding to a transmission bandwidth based on the detection result and the second channel information;
transmit, via the transceiver, a data frame through non-punctured sub-channels of the transmission bandwidth to the second apparatus based on the punctured sub-channel information; and
receive, via the transceiver, an acknowledgement frame from the second apparatus in response to the second apparatus receiving the data frame.

7. The apparatus for data transmission of claim 6, wherein the processor is further configured to:
transmit, via the transceiver, a first channel information to the second apparatus based on the detection result, wherein the second channel information comprises the first channel information; and
obtain the punctured sub-channel information corresponding to the transmission bandwidth based on the second channel information.

8. The apparatus for data transmission of claim 7, wherein the first channel information and the second channel information are control frames.

9. The apparatus for data transmission of claim 7, wherein the first channel information and the second channel information are management frames.

10. The apparatus for data transmission of claim 6, wherein the processor is further configured to:
transmit, via the transceiver, the data frame through non-punctured sub-channels of the transmission bandwidth based on the punctured sub-channel information and a specified puncture pattern list.

11. A data transmission method, comprising:
detecting, by a processor of a network node, whether there are any radar signals in a transmission bandwidth for a data transmission;
in response to a radar signal in at least one sub-channel of the transmission bandwidth, puncturing, by the processor, the at least one sub-channel; and
transmitting, by the processor, a first beacon frame to a user equipment (UE) to indicate the at least one punctured sub-channel in the transmission bandwidth.

12. The data transmission method of claim 11, further comprising:
determining, by the processor, whether the UE supports a puncture transmission; and
in response to the UE supporting the puncture transmission, transmitting, by the processor, the first beacon frame to the UE to indicate the at least one punctured sub-channel in the transmission bandwidth.

13. The data transmission method of claim 12, further comprising:
in response to the UE not supporting the puncture transmission, performing, by the processor, the data transmission according to a normal operation.

14. The data transmission method of claim 11, further comprising:
enabling, by the processor, a timer for the at least one punctured sub-channel; and
transmitting, by the processor, a second beacon frame to the UE in response to the timer being expired radar signal in the at least one punctured sub-channel,
wherein the second beacon frame indicates that the at least one punctured sub-channel is enabled again.

15. The data transmission method of claim 11, wherein in the puncturing of the at least one sub-channel, the method further comprises:
determining, by the processor, whether the at least one sub-channel which needs to be punctured meets a specified puncture pattern list; and
puncturing, by the processor, the at least one sub-channel in response to the at least one sub-channel meeting the specified puncture pattern list.

16. An apparatus for data transmission, comprising:
a transceiver, configured to perform wireless transmission and reception to and from a second apparatus;
a processor, coupled to the transceiver, and configured to:
detect whether there are any radar signals in a transmission bandwidth for a data transmission;
in response to a radar signal in at least one sub-channel of the transmission bandwidth, puncture the at least one sub-channel; and
transmit, via the transceiver, a first beacon frame to a user equipment (UE) to indicate the at least one punctured sub-channel in the transmission bandwidth.

17. The apparatus for data transmission of claim 16, wherein the processor is further configured to:
determine whether the UE supports a puncture transmission; and
in response to the UE supporting the puncture transmission, transmit, via the transceiver, the first beacon frame to the UE to indicate the at least one punctured sub-channel in the transmission bandwidth.

18. The apparatus for data transmission of claim 17, wherein the processor is further configured to:
perform the data transmission according to a normal operation in response to the UE not supporting the puncture transmission.

19. The apparatus for data transmission of claim 16, wherein the processor is further configured to:
enable a timer for the at least one punctured sub-channel; and
transmit, via the transceiver, a second beacon frame to the UE in response to the timer being expired and there being no radar signal in the at least one punctured sub-channel,
wherein the second beacon frame indicates that the at least one punctured sub-channel is enabled again.

20. The apparatus for data transmission of claim 16, wherein the processor is further configured to:
determine whether the at least one sub-channel which needs to be punctured meets a specified puncture pattern list; and
puncture the at least one sub-channel in response to the at least one sub-channel meeting the specified puncture pattern list.
